(19) United States
(12) Patent Application Publication
(10) Pub. No.: US 2010/0103554 A1
(43) Pub. Date: Apr. 29, 2010

(54) MEDIA ACCESS METHOD AND MAGNETIC STORAGE APPARATUS

(75) Inventor: Haruhiko Izumi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/556,303

(22) Filed: Sep. 9, 2009

(30) Foreign Application Priority Data
Oct. 27, 2008 (JP) 2008-275969

(51) Int. Cl. G11B 20/20

(52) U.S. Cl. 360/76; G9B/20.06

(57) ABSTRACT

According to one embodiment, a media access method includes a head scanning each track of a magnetic recording medium while tilting with respect to a direction perpendicular to the track direction at all positions including a position with a skew angle of zero on the magnetic recording medium. The track includes at least one magnetic dot array. The core width of the head is set with respect to a pitch of magnetic dots in the track direction and a pitch in the direction perpendicular to the track direction so that the head does not simultaneously scan a plurality of magnetic dots while scanning one track.

### CROSS-REFERENCE TO RELATED APPLICATIONS

This application is based upon and claims the benefit of priority from Japanese Patent Application No. 2008-275969, filed on Oct. 27, 2008, the entire contents of which are incorporated herein by reference.

### BACKGROUND

1. Field

One embodiment of the invention relates to a media access method and a magnetic storage apparatus, and in particular, to a media access method for patterned magnetic storage media and a magnetic storage apparatus using the same.

2. Description of the Related Art

There are demands for further downsizing magnetic storage apparatuses such as a magnetic disk apparatus and increasing the capacity, while magnetic recording media such as a magnetic disk are required to be increased in recording density. For the higher recording density of the magnetic recording media, patterned media or the like has been proposed.

FIG. 1 is a schematic diagram of a conventional patterned medium. Concentric-circle tracks 10 on a magnetic disk 1 include servo areas 13 for positioning a recording/replaying head 2, and data areas 11 for recording data. Each of the data areas 11 includes a magnetic dot array 12 preformed thereon as a pattern. Each of the servo areas 13 for positioning the recording/replaying head 2 on the magnetic dot array 12 forms an arc from the inner circumference side toward the outer circumference side of the magnetic disk 1 correspondingly to the seek of the recording/replaying head 2. Data is recorded by magnetizing the magnetic dots of the magnetic dot arrays 12 on the data areas 11 in the direction perpendicular to the surface of the magnetic disk 1 with the recording/replaying head 2. The track direction in which the tracks 10 extend on the magnetic disk 1 corresponds to the circumferential direction on the magnetic disk 1. The recording/replaying head 2 scans tracks with a predetermined floating amount from the surface of the magnetic disk 1 while moving rotationally in the direction of an arrow PD. The recording/replaying head 2 is provided on a slider 6 at an end of an arm 5. The recording/replaying head 2 has a skew angle (or yaw angle) correspondingly to the radius position on the magnetic disk 1. However, the servo areas 13 and the data areas 11 are arranged on the magnetic disk 1 so that data can be recorded/replayed regardless of the skew angle. The magnetic disk 1 rotates in the direction of an arrow RD. The track direction is perpendicular to the radius direction of the magnetic disk 1.

From the viewpoint of the higher recording density of the magnetic disk 1, it is desirable that the recording/replaying head 2 records/replays data with respect to each magnetic dot on the track 10 formed of one magnetic dot array (12). For that purpose, the recording/replaying head 2 with a very narrow core width is required not to scan the other magnetic dot arrays 12 adjacent to the one magnetic dot array 12.

However, production of the recording/replaying head 2 with such a very narrow core width is technically difficult. Accordingly, from the viewpoint of easy production of the recording/replaying head 2, it is desirable that data be recorded/replayed by using the recording/replaying head 2 with a relatively wide core width.

FIG. 2 is a schematic diagram illustrating a method for recording/replaying data by using the recording/replaying head 2 with a relatively wide core width. In this example, the recording/replaying head 2 has a core width W1 to simultaneously scan an adjacent pair of the magnetic dot arrays 12. In FIG. 2, D1 denotes a distance (or a pitch) between an adjacent pair of the magnetic dot arrays 12 in the radius direction, and L1 denotes a distance (or a pitch) between adjacent magnetic dots 112 on one magnetic dot array (12) in the track direction (i.e., circumferential direction).

In FIG. 2, D1=(L1/2)×tan 60°, while W1=2×D1=L1×tan 60°. Therefore, the area BA corresponding to one bit indicated by the dashed line is expressed as follows:

BA=2×D1×L1/2=D1×L1=(L12/2)×tan 60°

In this case, an adjacent pair of the magnetic dot arrays 12 correspond to one track. With the recording/replaying head 2 having a width almost equal to two arrays, data is recorded/replayed by alternately scanning the magnetic dots 112 of one magnetic dot array (12) and the magnetic dots 112 of the other magnetic dot array 12. Compared with the recording/replaying of data on the track formed of one magnetic dot array (12), the recording/replaying head 2 with about twice the core width is used to enable recording/replaying of data. Thus, the recording/replaying head 2 can easily be manufactured. On the other hand, it is difficult to further increase the recording density of the magnetic disk 1 because a pair of the magnetic dot arrays 12 form each of the tracks 10.

For a simple explanation, in FIG. 2, the skew angle is zero, which serves as a reference, while the recording/replaying head 2 is skewed correspondingly to the radius position on the magnetic disk 1. Reference may be had to, for example, Japanese Patent Application Publication (KOKAI) No. 2002-109712, Japanese Patent Application Publication (KOKAI) No. 2003-151103, and Japanese Patent Application Publication (KOKAI) No. 2004-39015.

The conventional technology has difficulty in increasing the recording density of the magnetic recording media without a very narrow core width of the recording/replaying head.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a conventional patterned medium;

FIG. 2 is an exemplary schematic diagram illustrating a method for recording/replaying data by using a recording/replaying head with a relatively wide core width;

FIG. 3 is an exemplary schematic diagram of a magnetic recording medium according to an embodiment of the invention;

FIG. 4 is an exemplary schematic diagram for explaining a first relationship between the recording/replaying head and a track in the embodiment;

FIG. 5 is an exemplary schematic diagram for explaining an allowable range for the tilt angle of the recording/replaying head when the first relationship is satisfied in the embodiment;

FIG. 6 is an exemplary schematic diagram for explaining a second relationship between the recording/replaying head and the track in the embodiment;

FIG. 7 is an exemplary schematic diagram for explaining an allowable range for the tilt angle of the recording/replaying head when the second relationship is satisfied in the embodiment;

FIG. 8 is an exemplary schematic diagram for explaining a third relationship between the recording/replaying head and the track in the embodiment;

FIG. 9 is an exemplary schematic diagram of a servo pattern in the embodiment;

FIG. 10 is an exemplary schematic diagram of another servo pattern in the embodiment;

FIGS. 11A to 11E are exemplary schematic diagrams for explaining how to form a magnetic dot in the embodiment;

FIG. 12 is an exemplary cross sectional view of part of a magnetic storage apparatus according to another embodiment of the invention; and

FIG. 13 is an exemplary top view of part of the magnetic storage apparatus in the embodiment.

### DETAILED DESCRIPTION

Various embodiments according to the invention will be described hereinafter with reference to the accompanying drawings. In general, according to one embodiment of the invention, there is provide a media access method. The media access method comprises a head scanning each track of a magnetic recording medium while tilting with respect to a direction perpendicular to the track direction at all positions including a position with a skew angle of zero on the magnetic recording medium. The track includes at least one magnetic dot array. The core width of the head is set with respect to a pitch of magnetic dots in the track direction and a pitch in the direction perpendicular to the track direction so that the head does not simultaneously scan a plurality of magnetic dots while scanning one track.

According to another embodiment of the invention, a magnetic storage apparatus comprises a magnetic recording medium and a recording/replaying head. On the magnetic recording medium, each track includes at least one magnetic dot array. The recording/replaying head is configured to scan the track while tilting with respect to a direction perpendicular to the track direction at all positions including a position with a skew angle of zero on the magnetic recording medium. The core width of the recording/replaying head is set with respect to a pitch of magnetic dots in the track direction and a pitch in the direction perpendicular to the track direction so that the recording/replaying head does not simultaneously scan a plurality of magnetic dots while scanning one track.

According to still another embodiment of the invention, a magnetic disk comprises a track including a servo area for positioning a head and a data area for recording data. The magnetic dot array is preformed in the data area as a pattern. The head is configured to magnetize each magnetic dot of the magnetic dot array in the data area in a direction perpendicular to a surface of the magnetic disk to record the data. The servo area forms an arc from the inner circumference toward outer circumference of the magnetic disk correspondingly to a seek of the head, and includes a servo pattern tilted correspondingly to the tilt angle of the head that performs scanning while tilting with respect to the radius direction in all radius positions including a radius position with a skew angle of zero.

On the magnetic recording medium in the media access method and the magnetic storage apparatus, each track is formed of one or more magnetic dot arrays. The recording/replaying head scans each track while tilting with respect to a direction perpendicular to the track direction at all positions including a position of a zero skew angle on the magnetic recording medium. The core width of the recording/replaying head is set with respect to a pitch of the magnetic dots in the track direction and a pitch in a direction perpendicular to the track direction so that the recording/replaying head does not simultaneously scan two or more magnetic dots while scanning one track.

This leads to the higher recording density of the magnetic recording medium without a very narrow core width of the recording/replaying head. If the core width is the same as the conventional one, higher recording density of the magnetic recording media can be obtained. If the recording density is the same as that of the conventional magnetic recording medium, a recording/replaying head with a wider core width than the conventional one can be obtained.

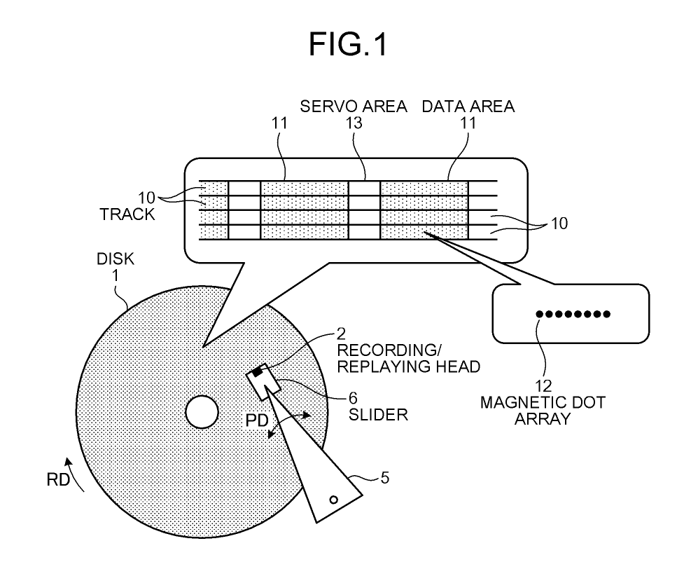

FIG. 3 illustrates an example of a patterned medium as a magnetic recording medium according to an embodiment of the invention. In FIG. 3, components corresponding to those in FIG. 1 are designated by the same reference numerals, and their description will not be repeated.

As explained later, in FIG. 3, the recording/replaying head 2 is provided on the arm 5 with the slider 6 interposed therebetween. The core of the recording/replaying head 2 extends in the radius direction of a magnetic disk 21 to be tilted toward a track direction (or a circumferential direction) from a state of the zero skew angle. Here, the tilted angle is set within an allowable range. The recording/replaying head 2 has a core width set with respect to a pitch in the track direction of the magnetic dots and a pitch in the direction perpendicular to the track direction so as not to simultaneously scan two or more magnetic dots during a scan of one track.

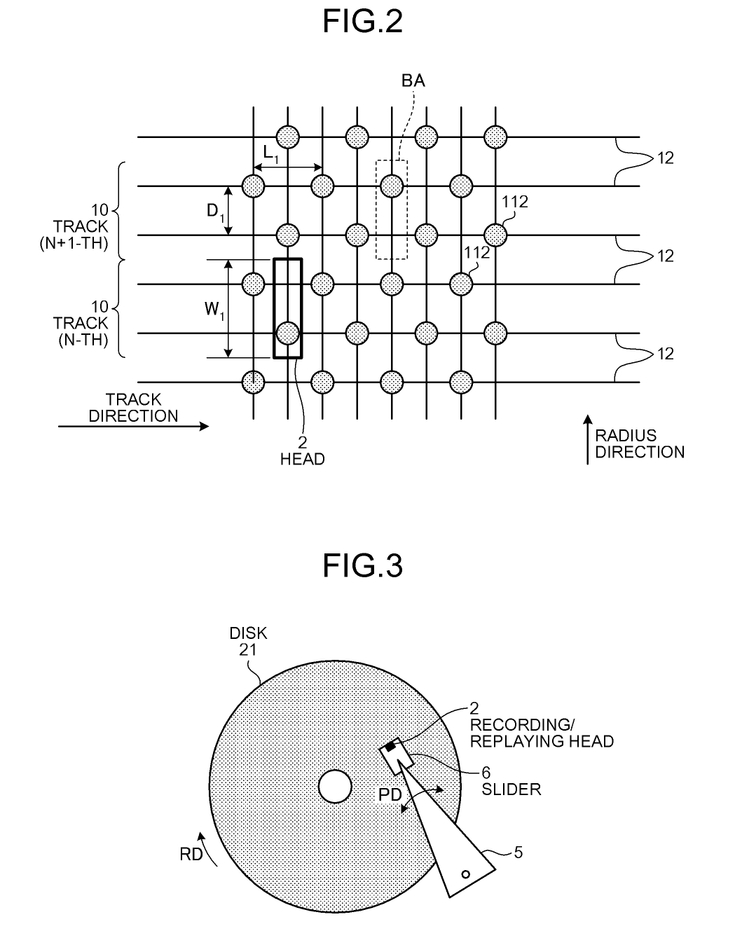

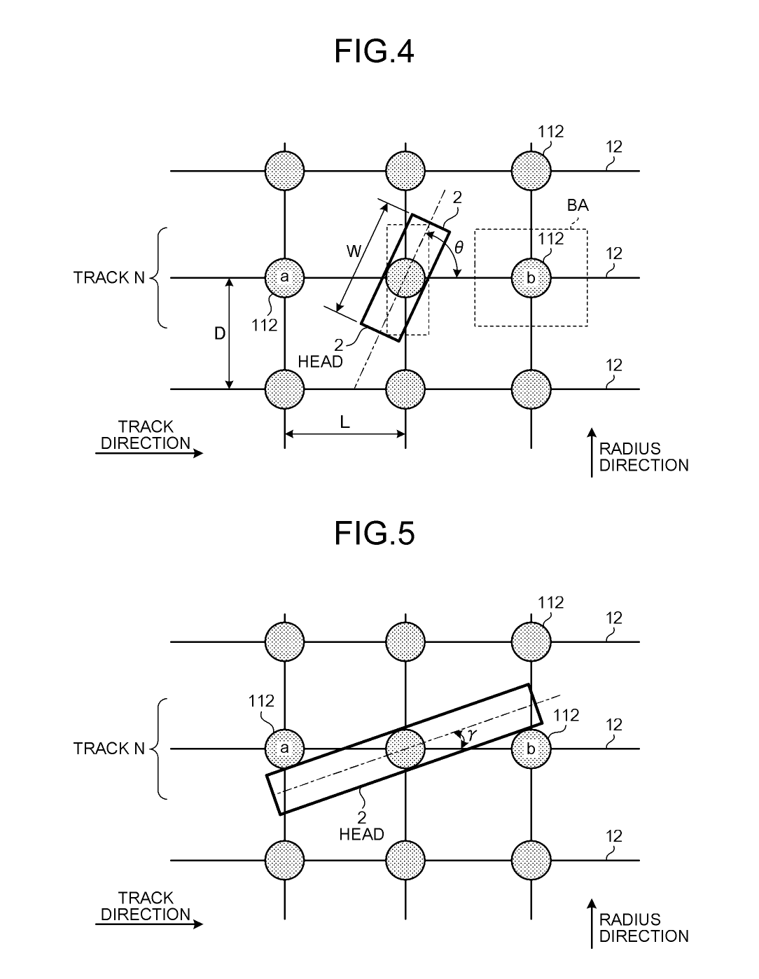

FIG. 4 is a schematic diagram for explaining a first relationship between the recording/replaying head 2 and the track. FIG. 5 is a schematic diagram for explaining an allowable range for the tilt angle of the recording/replaying head 2 when the first relationship is satisfied. In FIGS. 4 and 5, the components corresponding to those of FIG. 2 are designated by the same reference numerals, and their description will not be repeated. In FIG. 4, D denotes a distance (or pitch) between an adjacent pair of the magnetic dot arrays 12 in the radius direction, and L denotes a distance (or pitch) between an adjacent pair of the magnetic dots 112 on one magnetic dot array in the track direction (i.e., circumferential direction). W denotes a core width of the recording/replaying head 2. The area BA corresponding to one bit denoted by the dashed line is expressed as BA=D×L. By using the pitches D1 and L1 in the conventional example of FIG. 2, this is expressed as: BA=D1×L1/2=(L12/4)×tan 60°. A “track N” denotes an N-th track from any reference position (or track) on the magnetic disk 21 in FIG. 4 and the subsequent drawings.

In FIG. 4, each track such as a track N is formed of one magnetic dot array (12). The magnetic dot 112 on the data area is placed on a rectangular lattice point in the zero skew angle. The core of the recording/replaying head 2 is tilted with respect to the track direction to scan only the magnetic dots 112 on a track formed of one magnetic dot array (12) (e.g., track N) one-by-one. θ denotes an angle between the track direction and the direction along the width W of the recording/replaying head 2, i.e., a tilt angle of the recording/replaying head 2. When W(θ)=D/sin θ holds, the recording/replaying head 2 does not scan the magnetic dots 112 of the upward and downward adjacent tracks, during the scan of the track N. When θ=60°, for example, W(60°)=2/√3×W(90°)=1.2×W(90°) is established.

On the other hand, as illustrated in FIG. 5, when the tilt angle θ of the recording/replaying head 2 is equal to or less than an angle γ, during the scan of the middle magnetic dot 112 of the track N, the recording/replaying head 2 scans the adjacent magnetic dots 112 to the track direction, denoted by a and b in the same track N. Accordingly, if an allowable range for the tilt angle θ of the recording/replaying head 2 (core) is set to γ<θ<(180-γ) (except for θ=90°), when scanning the middle magnetic dot 112 of the track N, the recording/replaying head 2 does not scan the adjacent magnetic dots 112 to the track direction, denoted by a and b, in the same track N.

In the conventional recording/replaying method, when the recording/replaying head is at the zero skew angle, for example, while scanning one track, a period not to scan a magnetic dot is inevitable during the scan from one magnetic dot to the next magnetic dot. On the contrary, if the allowable range for the tilt angle θ of the recording/replaying head 2 is set to satisfy the first relationship, while scanning one track, the recording/replaying head 2 scans the magnetic dots 112 without interruption during the scan from one magnetic dot (112) to the next magnetic dot 112, as can be seen from FIG. 5. That is, the recording/replaying head 2 continuously scans the adjacent magnetic dots 112 during the scan of one track. This achieves about a double data transfer rate at the time of the recording/replaying, compared with the conventional recording/replaying method.

In the embodiment, the tilt angle θ of the recording/replaying head 2 is deliberately set, and is thus different from the skew angle formed correspondingly to a radius position on the magnetic disk 21. In the conventional recording/replaying method, the recording/replaying head is not tilted at the reference position of the zero skew angle on the magnetic disk. In the embodiment, however, the recording/replaying head 2 has a tilt angle θ (>0) regardless of the radius positions on the magnetic disk 21 (even at the position of the zero skew angle). This tilt angle θ includes the skew angle. Therefore, to set the tilt angle θ within the allowable range: γ<θ<(180-γ), the tilt angle θ that includes the largest skew angle on the magnetic disk 21 needs to be taken into account.

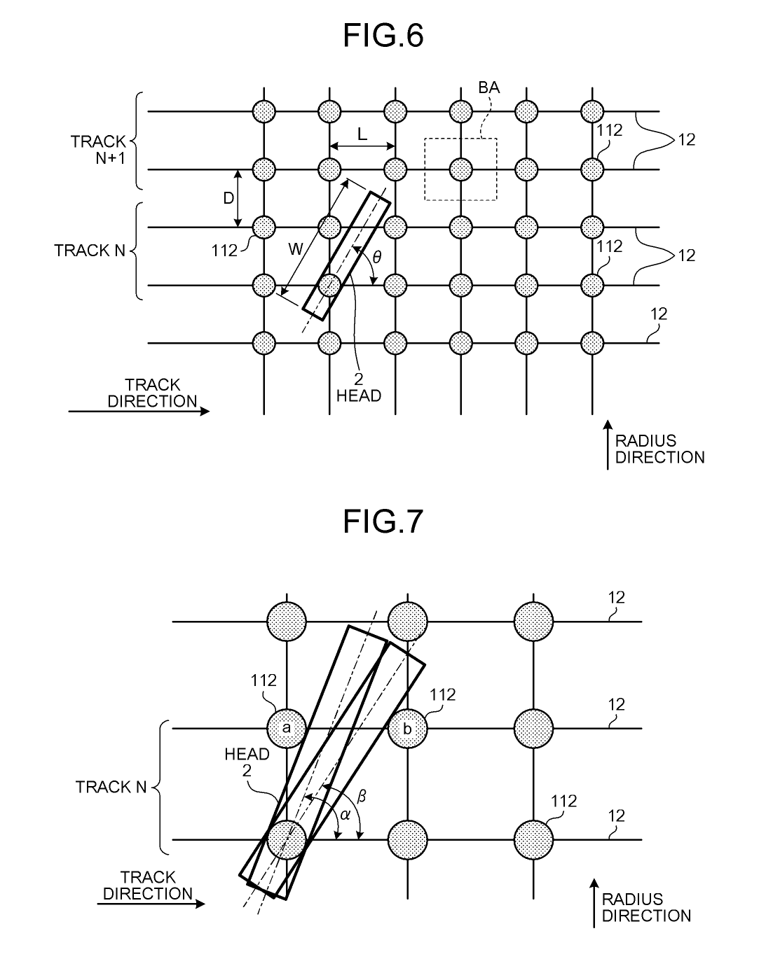

FIG. 6 is a schematic diagram for explaining a second relationship between the recording/replaying head and the track. FIG. 7 is a schematic diagram for explaining an allowable range for the tilt angle of the recording/replaying head when the second relationship is satisfied. In FIGS. 6 and 7, the components corresponding to those of FIGS. 4 and 5 are designated by the same reference numerals, and their description will not be repeated. The area BA corresponding to one bit is the same as that of FIG. 4.

In FIG. 6, each track such as a track N and a track N+1 is formed of two magnetic dot arrays 12. The magnetic dot 112 on the data area is placed on a square lattice point with a skew angle of zero. The core of the recording/replaying head 2 is tilted with respect to the track direction to alternately scan the magnetic dots 112 on a track formed of two magnetic dot arrays 12 (e.g., track N). To be accurate, the pitch L between the magnetic dots 112 increases per magnetic dot array (12) from the inner circumference side toward the outer circumference side of the magnetic disk 21, and the tracks form concentric-circles, so that each of the magnetic dots 112 on the data areas is placed on a lattice point in a sector form. However, the lattice point in the sector form is also referred herein to as the square lattice point (or the rectangular lattice point) to describe the characteristics of such staggered arrays. θ denotes an angle between the track direction and the direction along the width W of the recording/replaying head 2, i.e., a tilt angle of the recording/replaying head 2. When W=√((2×D)2+L2) holds, the recording/replaying head 2 does not scan the magnetic dots 112 of the upward and downward adjacent tracks, during the scan of the track N.

On the other hand, as illustrated in FIG. 7, when the tilt angle θ of the recording/replaying head 2 is equal to or larger than an angle α, during the scan of the magnetic dot 112 of the downward magnetic dot array 12 on the track N, the recording/replaying head 2 scans the magnetic dot 112 of the upward magnetic dot array 12, denoted by a in the same track N. When the tilt angle θ of the recording/replaying head 2 is equal to or less than an angle β, during the scan of the magnetic dot 112 of the downward magnetic dot array 12 on the track N, the recording/replaying head 2 scans the magnetic dot 112 of the upward magnetic dot array 12, denoted by b in the same track N. Accordingly, if an allowable range for the tilt angle θ of the recording/replaying head 2 (core) is set to β<θ<α (except for θ=90°), when scanning the magnetic dot 112 of the downward magnetic dot array 12 on the track N, the recording/replaying head 2 does not scan the magnetic dots 112 of the upward magnetic dot array 12, denoted by a and b in the same track N.

In the conventional recording/replaying method of FIG. 2, when the recording/replaying head is at the zero skew angle, for example, while scanning one track formed of two magnetic dot arrays, a period not to scan a magnetic dot is inevitable during the scan from one magnetic dot of one magnetic dot array to the next magnetic dot of the other magnetic dot array. On the contrary, if the allowable range for the tilt angle θ of the recording/replaying head 2 is set to satisfy the second relationship, while scanning one track, the recording/replaying head 2 scans the magnetic dots 112 without interruption during the scan from one magnetic dot (112) of one magnetic dot array (12) to the next magnetic dot 112 of the other magnetic dot array 12, as can be seen from FIG. 7. That is, the recording/replaying head 2 alternately scans the magnetic dots 112 of two magnetic dot arrays (12) forming one track in a continuous manner, during the scan of one track. This achieves about a double data transfer rate at the time of the recording/replaying, compared with the conventional recording/replaying method.

In the embodiment, the tilt angle θ of the recording/replaying head 2 is deliberately set, and is thus different from the skew angle formed correspondingly to a radius position on the magnetic disk 21. In the conventional recording/replaying method, the recording/replaying head is not tilted at the reference position of the zero skew angle on the magnetic disk. In the embodiment, however, the recording/replaying head 2 has a tilt angle θ (>0) regardless of the radius positions on the magnetic disk 21 (even at the position of the zero skew angle). This tilt angle θ includes the skew angle. Therefore, to set the tilt angle θ within the allowable range: β<θ<α, the tilt angle θ that includes the largest skew angle on the magnetic disk 21 needs to be taken into account.

When θ=60° in FIG. 6, compared with the conventional example of FIG. 2, D=√((L12/2)×tan 60°)=D1×√(2/tan 60°)=1.0746×D1 is established. Therefore, the pitch D in the radius direction is 1.0746 times the pitch D1 in FIG. 2. As for the pitch L in the track direction, L=√((L12/2)×tan 60°=L1×√tan 60°/2)=0.9306×L1 is established. Therefore, the pitch L in the track direction is 0.9306 times the pitch L1 in FIG. 2. Further, W=√((2×D)2+L2)=W1×√(5/(2×tan 60°))=1.2014×W1 is established. Accordingly, the core width W of the recording/replaying head 2 can be set to 1.2014 times the core width W1 in FIG. 2.

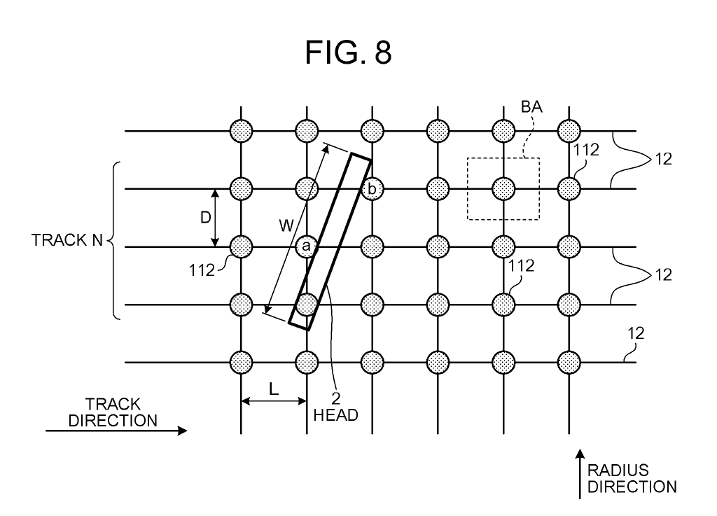

FIG. 8 is a schematic diagram for explaining a third relationship between the recording/replaying head and the track. In FIG. 8, the components corresponding to those of FIGS. 4 and 5 are designated by the same reference numerals, and their description will not be repeated. The area BA corresponding to one bit is the same as that of FIG. 4.

In FIG. 8, each track such as a track N is formed of three magnetic dot arrays (12). The magnetic dot 112 on the data area is placed on the square lattice point in the zero skew angle. The core of the recording/replaying head 2 is tilted with respect to the track direction to sequentially scan the magnetic dots 112 on a track formed of three magnetic dot arrays (12) (e.g., track N), and not to simultaneously scan two or more magnetic dots (112) of the three magnetic dot arrays 12. θ denotes an angle between the track direction and the direction along the width W of the recording/replaying head 2, i.e., a tilt angle of the recording/replaying head 2. When W=√((3×D)2+L2) holds, the recording/replaying head 2 does not scan the magnetic dots 112 of the upper tracks, during the scan of the track N.

On the other hand, when the tilt angle θ of the recording/replaying head 2 is equal to or larger than an angle α, during the scan of the magnetic dot 112 of the downward magnetic dot array 12 on the track N, the recording/replaying head 2 scans the magnetic dot 112 of the middle magnetic dot array 12, denoted by a in the same track N. When the tilt angle θ of the recording/replaying head 2 is equal to or less than an angle β, during the scan of the magnetic dot 112 of the downward magnetic dot array 12 on the track N, the recording/replaying head 2 scans the magnetic dot 112 of the upward magnetic dot array 12, denoted by b in the same track N. Accordingly, if an allowable range for the tilt angle θ of the recording/replaying head 2 (core) is set to β<θ<α (except for θ=90°), when scanning the magnetic dot 112 of the downward magnetic dot array 12 on the track N, the recording/replaying head 2 does not scan the magnetic dots 112 of the middle and the upward magnetic dot arrays 12, denoted by a and b in the same track N.

In conceivable media access methods, when the recording/replaying head is at the zero skew angle, for example, while scanning one track formed of three magnetic dot arrays, a period not to scan a magnetic dot is inevitable during the scan from one magnetic dot of one magnetic dot array to the next magnetic dot of the other magnetic dot array. On the contrary, if the allowable range for the tilt angle θ of the recording/replaying head 2 is set to satisfy the third relationship, while scanning one track, the recording/replaying head 2 scans the magnetic dots 112 without interruption during the scan from one magnetic dot (112) of one magnetic dot array (12) to the next magnetic dot 112 of the other magnetic dot array 12, as can be seen from FIG. 8. That is, during the scan of one track, the recording/replaying head 2 sequentially and continuously scans the magnetic dots 112 of three magnetic dot arrays (12) forming one track one-by-one. This achieves about a double data transfer rate at the time of the recording/replaying, compared with the conceivable media access methods.

In the embodiment, the tilt angle θ of the recording/replaying head 2 is deliberately set, and is thus different from the skew angle formed correspondingly to a radius position on the magnetic disk 21. In the conventional recording/replaying method, the recording/replaying head is not tilted at the reference position of the zero skew angle on the magnetic disk. In the embodiment, however, the recording/replaying head 2 has a tilt angle θ (>0) regardless of the radius positions on the magnetic disk 21 (even at the position of the zero skew angle). This tilt angle θ includes the skew angle. Therefore, to set the tilt angle θ within the allowable range: β<θ<α, the tilt angle θ that includes the largest skew angle on the magnetic disk 21 needs to be taken into account.

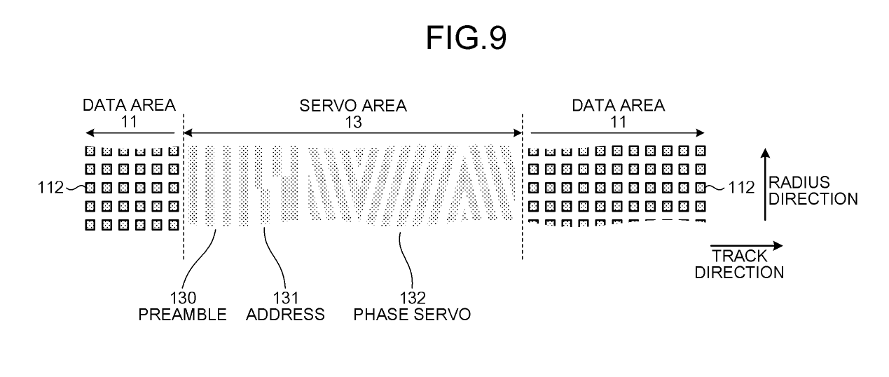

FIG. 9 is a schematic diagram of a servo pattern. In the embodiment, the arrangement of the data areas 11 and the servo areas 13 on each track is the same as described previously in connection with FIG. 1. The servo area 13, which is enlargedly illustrated in FIG. 9, includes a preamble 130 that reads a servo signal in synchronization with clocks, an address 131 that indicates a track number and a sector number, and a phase servo 132 that detects positional shift between the recording/replaying head 2 and a track. The address 131 includes a sync mark. The sync mark is followed by a track number and a sector number, with a servo pattern of the servo area 13 being detected. The servo area 13 is formed by arranging a magnetic pattern and a non-magnetic pattern in a process to form the magnetic dots on the data area 11 in the same manner. The servo area 13 is an embedded servo pattern whose magnetization is initialized to be magnetized in the direction perpendicular to the surface of the magnetic disk 1.

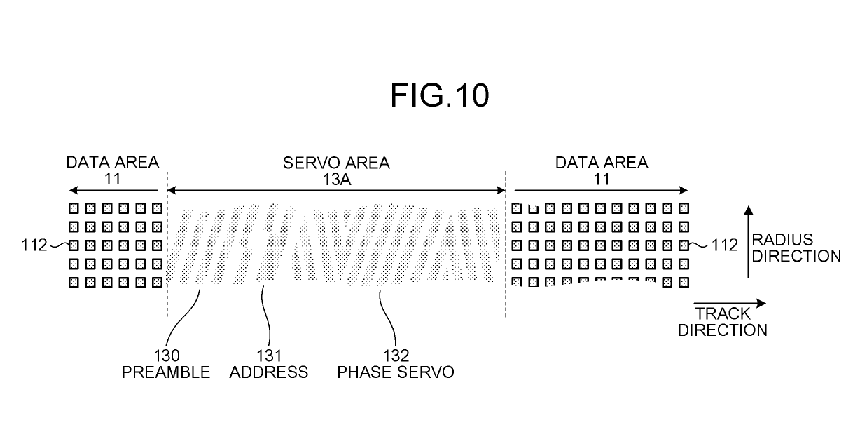

FIG. 10 is a schematic diagram of another servo pattern. In FIG. 10, the components corresponding to those of FIG. 9 are designated by the same reference numerals, and their description will not be repeated. The servo pattern on the servo area 13 in FIG. 9 is a pattern formed with the reference of the zero skew angle, basically in the same manner as the conventional one without specifically taking account of the tilt angle θ of the recording/replaying head 2. On the other hand, a servo pattern on a servo area 13A in FIG. 10 per se is designed to have a tilt angle with consideration for the tilt angle θ of the recording/replaying head 2 (including the skew angle). This achieves more precise and accurate replaying of the servo pattern by the recording/replaying head 2 with the tilt angle θ.

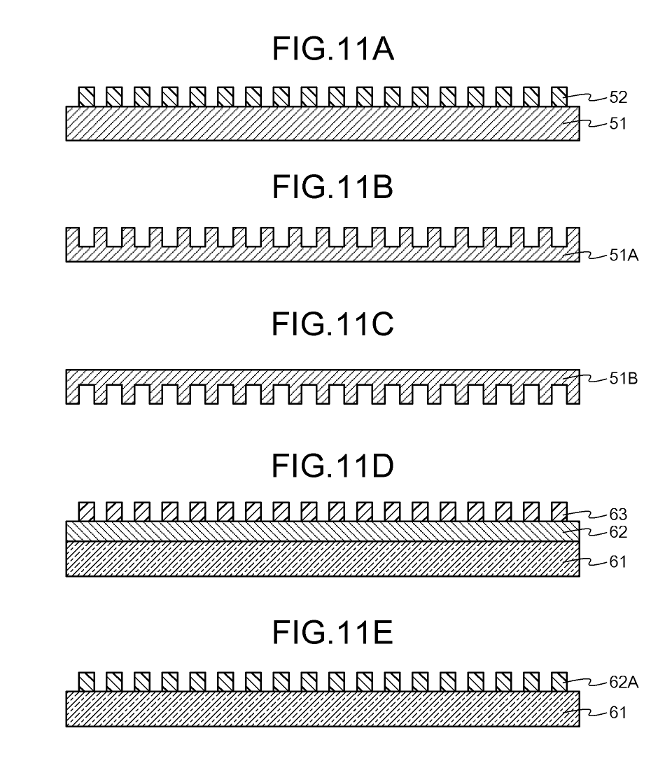

FIGS. 11A to 11E for explaining how to form a magnetic dot. The magnetic dots 112 on the magnetic disk 21 are each formed into the rectangular lattice point or the square lattice point as follows.

Initially, a resist film spin-coated on a substrate for a stamper 51 is etched by electron beam exposure, as illustrated in FIG. 11A, to prepare a resist pattern 52 that has portions corresponding to the magnetic dots 112. Then, the resist pattern 52 is used to form a template pattern (mold) illustrated in FIG. 11B by etching. A template pattern 51A is transferred by nickel electroforming to form a stamper 51B illustrated in FIG. 11C.

The pattern of the stamper 51B is transferred on a resist of a magnetic film 62 formed on a media substrate 61 by nanoimprint to form a resist pattern 63 in FIG. 11D. The resist pattern 63 is used to process the magnetic film 62 by etching to form a pattern 62A of the magnetic dots 112 in FIG. 11E. The position and the shape of the magnetic dots 112 to be formed in FIG. 11E are determined by the exposure pattern at the time of the electron beam exposure in FIG. 11A. Hence, the electron beam exposure is conducted in such a manner that the magnetic dots 112 on the data area 11 are formed as illustrated in FIG. 4, 6, or 8.

The servo area 13 (or 13A) may basically be formed with the reference of the zero skew angle in the same manner as the conventional one without specifically taking account of the tilt angle θ of the recording/replaying head 2, as illustrated in FIG. 9. Alternatively, the servo area 13 (or 13A) may be designed to have a tilt angle with consideration for the tilt angle θ of the recording/replaying head 2 (including the skew angle), as illustrated in FIG. 10.

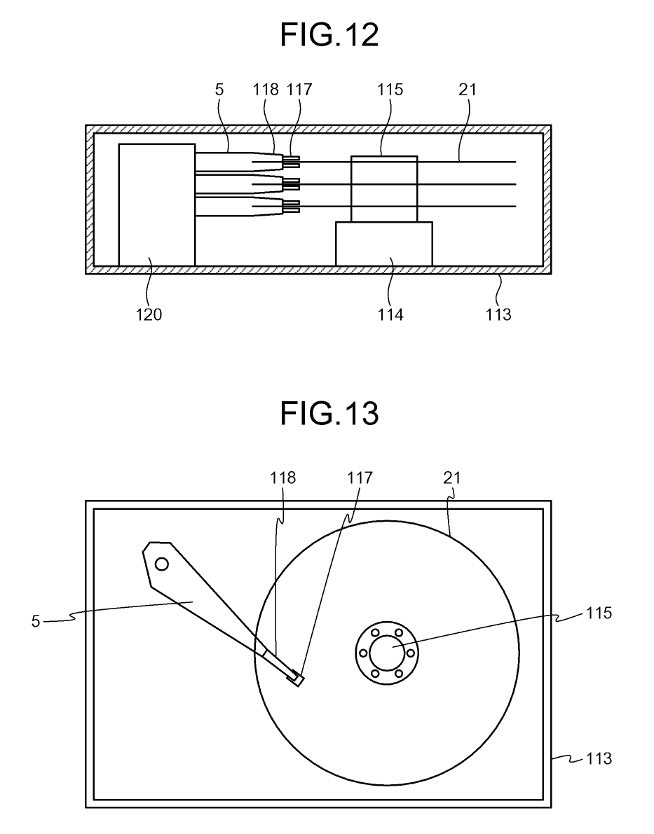

A magnetic storage apparatus according to another embodiment of the invention will be explained with reference to FIGS. 12 and 13. In this embodiment, the magnetic storage apparatus includes a plurality of magnetic recording media. FIG. 12 is a cross sectional view of part of the magnetic storage apparatus. FIG. 13 is a top view of part of the magnetic storage apparatus without the top cover.

In FIGS. 12 and 13, a motor 114 is mounted on a base 113. The motor 114 rotates a hub 115 that fixes a plurality of magnetic disks (21). The magnetic disks 21 are of basically the same configuration as described above. The recording/replaying head 2 (not illustrated) attached to a slider 117 is used to read information from or write information to each of the magnetic disks 21. The recording/replaying head 2 is arranged to have a tilt angle θ (>0) within an allowable angle (except for θ=90°) as described above, at all radius positions including the zero skew angle on each of the magnetic disks 21.

The slider 117 is connected to a suspension 118. The suspension 118 presses the slider 117 against a direction of a recording surface (face) of the magnetic disk 21. On the recording surface of the magnetic disk 21, a lubricating layer made with lubricant is provided. At specific disk rotation speed and suspension hardness, the slider 117 scans a position floated by a predetermined floating amount from the recording surface of the magnetic disk 21. The suspension 118 is fixed to the robust arm 5 connected to an actuator 120. This enables reading and writing of information over wider range of the magnetic disks 21.

It should be noted that the number of the magnetic disks 21 is not limited to three as illustrated in FIG. 12. Two magnetic disks (21) or four or more magnetic disks (21) may be installed in the magnetic storage apparatus.

Further, the magnetic recording medium according to the embodiments is not limited to a magnetic disk. The embodiments is applicable to various types of magnetic recording media including magnetic cards.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented byway of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A media access method comprising:
a head scanning each track of a magnetic recording medium while tilting with respect to a direction perpendicular to a track direction at all positions including a position with a skew angle of zero on the magnetic recording medium, the track including at least one magnetic dot array, wherein
a core width of the head is set with respect to a pitch of magnetic dots in the track direction and a pitch in the direction perpendicular to the track direction so that the head does not simultaneously scan a plurality of magnetic dots while scanning one track.

2. The media access method according to claim 1, wherein
the track includes one magnetic dot array, and
when the head scans a magnetic dot on the track, a tilt angle of the head is set within an allowable range in which the head does not scan adjacent magnetic dots in the track direction on the track.

3. The media access method according to claim 1, wherein
the track includes a first magnetic dot array and a second magnetic dot array,
when the head scans a magnetic dot of the first magnetic dot array, a tilt angle of the head is set within an allowable range in which the head does not scan a magnetic dot of the second magnetic dot array, and
the head is configured to alternately scan a magnetic dot of the first magnetic dot array and a magnetic dot of the second magnetic dot array.

4. The media access method according to claim 1, wherein
the track includes a first magnetic dot array, a second magnetic dot array, and a third magnetic dot array,
when the head scans a magnetic dot of the first magnetic dot array, a tilt angle of the head is set within an allowable range in which the head does not scan a magnetic dot of the second magnetic dot array and the third magnetic dot array, and
the head is configured to sequentially scan a magnetic dot of the first magnetic dot array, a magnetic dot of the second magnetic dot array, and a magnetic dot of the third magnetic dot array.

5. A magnetic storage apparatus comprising:
a magnetic recording medium on which each track includes at least one magnetic dot array; and
a recording/replaying head configured to scan the track while tilting with respect to a direction perpendicular to a track direction at all positions including a position with a skew angle of zero on the magnetic recording medium, wherein
a core width of the recording/replaying head is set with respect to a pitch of magnetic dots in the track direction and a pitch in the direction perpendicular to the track direction so that the recording/replaying head does not simultaneously scan a plurality of magnetic dots while scanning one track.

6. The magnetic storage apparatus according to claim 5, wherein
the track of the magnetic recording medium includes one magnetic dot array, and
when the recording/replaying head scans a magnetic dot on the track, a tilt angle of the recording/replaying head is set within an allowable range in which the recording/replaying head does not scan adjacent magnetic dots in the track direction on the track.

7. The magnetic storage apparatus according to claim 5, wherein
the track of the magnetic recording medium includes a first magnetic dot array and a second magnetic dot array,
when the recording/replaying head scans a magnetic dot of the first magnetic dot array, a tilt angle of the recording/replaying head is set within an allowable range in which the recording/replaying head does not scan a magnetic dot of the second magnetic dot array; and
the recording/replaying head is configured to alternately scan a magnetic dot of the first magnetic dot array and a magnetic dot of the second magnetic dot array.

8. The magnetic storage apparatus according to claim 5, wherein
the track of the magnetic recording medium includes a first magnetic dot array, a second magnetic dot array, and a third magnetic dot array,
when the recording/replaying head scans a magnetic dot of the first magnetic dot array, a tilt angle of the recording/replaying head is set within an allowable range in which the recording/replaying head does not scan a magnetic dot of the second magnetic dot array and the third magnetic dot array, and
the recording/replaying head is configured to sequentially scan a magnetic dot of the first magnetic dot array, a magnetic dot of the second magnetic dot array, and a magnetic dot of the third magnetic dot array.

9. The magnetic storage apparatus according to claim 5, wherein
the tracks of the magnetic recording medium includes a servo area for positioning the recording/replaying head and a data area for recording data,
the magnetic dot array is preformed in the data area as a pattern, and
the servo area forms an arc from inner circumference toward outer circumference of the magnetic recording medium correspondingly to a seek of the recording/replaying head, and includes a servo pattern tilted correspondingly to a tilt angle of the recording/replaying head that performs scanning while tilting with respect to the direction perpendicular to the track direction at all the positions including the position with a skew angle of zero on the magnetic recording medium.

10. The magnetic storage apparatus according to claim 5, wherein the magnetic recording medium is a magnetic disk.

11. A magnetic disk comprising:
a track including a servo area for positioning a head, and a data area for recording data, wherein
a magnetic dot array is preformed in the data area as a pattern,
the head is configured to magnetize each magnetic dot of the magnetic dot array in the data area in a direction perpendicular to a surface of the magnetic disk to record the data, and
the servo area forms an arc from inner circumference toward outer circumference of the magnetic disk correspondingly to a seek of the head, and includes a servo pattern tilted correspondingly to a tilt angle of the head that performs scanning while tilting with respect to a radius direction in all radius positions including a radius position with a skew angle of zero.
